(19) United States
(12) Patent Application Publication
(10) Pub. No.: US 2026/0055328 A1
(43) Pub. Date: Feb. 26, 2026

(54) PLASTIC LIQUEFACTION USING NOVEL SOLID ALUMINA COMPOSITION

(71) Applicant: BRASKEM AMERICA, INC., Philadelphia, PA (US)

(72) Inventors: Vibin VARGHEESE, Pittsburgh, PA (US); Dan XIE, Pittsburgh, PA (US); Nicholas WANG, Pittsburgh, PA (US); Matthew FEENEY, Pittsburgh, PA (US)

(21) Appl. No.: 19/305,230

(22) Filed: Aug. 20, 2025

Related U.S. Application Data
(60) Provisional application No. 63/686,555, filed on Aug. 23, 2024.

(51) Int. Cl. C10G 47/12; B01J 21/04; B01J 27/04; B01J 37/08

(52) U.S. Cl. CPC C10G 47/12; B01J 21/04; B01J 27/04; B01J 37/08; B01J 2235/15; C10G 2300/1007; C10G 2300/1011; C10G 2300/4006; C10G 2300/4012; C10G 2400/28

(57) ABSTRACT

The disclosure provides a process for hydrocracking a carbon-containing feedstock, including: reacting a carbon-containing feedstock and hydrogen stream in the presence of a hydrocracking catalyst to produce an alkane-containing product stream; where the hydrocracking catalyst comprises a solid alumina composition as a catalyst support, where the solid alumina composition is prepared from a precursor composition comprising an alumina hydroxide (Al(OH)₃), aluminum oxyhydroxide (AlO(OH)), or a mixture thereof.

### CROSS-REFERENCE TO RELATED APPLICATIONS

The present application claims the benefit of U.S. Provisional Patent Application No. 63/686,555, filed on Aug. 23, 2024.

### BACKGROUND OF THE INVENTION

Plastic waste is a diverse feedstock which may consist of several polymers, fillers/stabilizing agents, and contaminants. The inconsistent quality of the feedstock provides a technical challenge in the conversion of plastics to chemicals. Thus, there is a need in the art for a robust process and stable catalysts necessary to perform the chemical upcycling.

The present invention relates to an application of a novel solid alumina composition, prepared from an acid-treated precursor composition as the catalyst support, to the plastic hydrocracking with significantly improved performance (e.g., catalyst activity, reactivity). This improved catalyst performance and hydrocracking performance is particularly seen when compared to the conventional gamma alumina support.

Advantages of the application include: the application can use biobased, renewable feedstocks; it can also promote better energy efficiency and/or achieve carbon emission reductions; and it employs a novel solid alumina composition prepared from an acid-treated precursor composition, as described herein, which has a higher acid site concentration and provides a higher activity for the plastic hydrocracking than the conventional gamma alumina support.

### BRIEF SUMMARY OF THE INVENTION

An embodiment of the present invention relates to a solid alumina composition prepared from an acid-treated precursor composition, said precursor composition comprising an alumina hydroxide (Al(OH)₃), aluminum oxyhydroxide (AlO(OH)), or a mixture thereof; wherein the solid alumina composition comprises η-alumina characterized by having an X-ray powder diffraction pattern comprising the peaks at 19.6±0.5 °2θ and 66.8±0.5 °2θ; and wherein the solid alumina composition has an acidity measured by an NH₃-TPD test, characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment of the present invention relates to a solid alumina composition above, which comprises η-alumina at a high purity, characterized by a ratio of a peak intensity at 19.6±0.5 °2θ, relative to a peak intensity at 66.8±0.5 °2θ, being about 3% or greater, preferably from about 3% to about 10%, or preferably from about 6% to about 10%.

Another embodiment of the present invention relates to a solid alumina composition above, which has an acidity measured by an NH₃-TPD test, characterized by: (1) an acid site density ranging from about 200 to 800 μmol.

Another embodiment of the present invention relates to a solid alumina composition above, which has an acidity measured by an NH₃-TPD test, characterized by: (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment of the present invention relates to a solid alumina composition above, which comprises an acidity measured by an NH₃-TPD test, characterized by: (1) an acid site density ranging from about 250 to about 800, preferably from about 300 to about 800, or preferably from about 400 to about 800 μmol/g.

Another embodiment of the present invention relates to a solid alumina composition above, wherein the alumina hydroxide comprises bayerite.

Another embodiment of the present invention relates to a solid alumina composition above, wherein the aluminum oxyhydroxide comprises boehmite (γ-AlO(OH)), pseudo-boehmite (e.g., finely crystalline boehmite), or a mixture thereof.

Another embodiment of the present invention relates to a solid alumina composition above, wherein the precursor composition comprises a mixture of bayerite and boehmite or pseudo-boehmite, optionally containing over 50 wt % (such as over 60 wt %, over 70 wt %, over 80 wt %, over 90 wt %, or over 95 wt %) bayerite.

Another embodiment of the present invention relates to a solid alumina composition above, wherein an acid to obtain the acid-treated precursor composition, comprises an acid selected from the group consisting of an inorganic acid, a halogen acid, an organic acid, and a mixture thereof.

Another embodiment of the present invention relates to a solid alumina composition above, wherein the acid comprises an inorganic acid selected from the group consisting of sulfuric acid, boric acid, nitric acid, and a mixture thereof.

Another embodiment of the present invention relates to a solid alumina composition above, wherein the acid comprises a halogen acid selected from the group consisting of hydrochloric acid, hydrobromic acid, and a mixture thereof.

Another embodiment of the present invention relates to a solid alumina composition above, wherein the acid comprises an organic acid selected from the group consisting of acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, and a mixture thereof.

Another embodiment of the present invention relates to a solid alumina composition above, wherein the acid comprises an acid selected from the group consisting of nitric acid, acetic acid, citric acid, malic acid, tartaric acid, or a mixture thereof.

Another embodiment of the present invention relates to a process for preparing a solid alumina composition, the process comprising: treating a precursor composition comprising an alumina hydroxide (Al(OH)₃), aluminum oxyhydroxide (AlO(OH)), or a mixture thereof with an acid, to form an acid-treated precursor composition; dispersing the acid-treated precursor composition into a homogenous aqueous suspension of particles; drying the homogenous aqueous suspension of particles; and calcinating the dried particles, to form a solid alumina composition.

Another embodiment of the present invention relates to a process above, wherein the dispersing is carried out by sonication, stirring, shaking, or a combination thereof.

Another embodiment of the present invention relates to a process above, wherein adding a surfactant to the homogenous aqueous suspension of particles.

Another embodiment of the present invention relates to a process above, wherein the surfactant comprises a cationic surfactant, an anionic surfactant, or a combination thereof.

Another embodiment of the present invention relates to a process above, wherein the cationic surfactant comprises a salt of a quaternary ammonium cation selected from the group consisting of cetyltrimethylammonium, cetylpyridinium, polydially dimethyl ammonium, and a combination thereof, and wherein the anionic surfactant comprises a surfactant selected from the group consisting of an alkyl sulfate, an alkyl-ether sulfate, an alkylbenzene sulfonate, a perfluoroalkanesulfonate, an alkyl-aryl ether phosphate, an alkyl ether phosphate, sodium stearate, and a combination thereof.

Another embodiment of the present invention relates to a process above, wherein the non-ionic surfactant comprises at least one member selected from the group consisting of a fatty alcohol ethoxylate, an alkyl phenol ethoxylate, a fatty acid alkoxylate, an ethylene oxide/propylene oxide copolymer, and a poly(ethylene oxide)-based surfactant.

Another embodiment of the present invention relates to a process above, wherein the poly(ethylene oxide)-based surfactant comprises at least one of TERGITOL 15-S-5, TERGITOL 15-S-7, TERGITOL 15-S-9, and TERGITOL 15-S-12.

Another embodiment of the present invention relates to a process above, wherein the surfactant comprises cetyltrimethylammonium bromide, poly-diallyldimethylammonium chloride, or Tergitol 15-S-7.

Another embodiment of the present invention relates to a process above, wherein the drying is carried out at a temperature ranging from about 20° C. to about 200° C., preferably from about 50° C. to about 150° C., or preferably from about 90° C. to about 100° C.

Another embodiment of the present invention relates to a process above, further comprising, prior to calcinating: cooling the dried particles to an ambient temperature.

Another embodiment of the present invention relates to a process above, wherein the calcinating is carried out at a temperature ranging from about 400° C. to about 750° C., preferably from about 500° C. to about 650° C.

Another embodiment of the present invention relates to a process above, wherein the calcinating is carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

Another embodiment of the present invention relates to a process above, wherein the calcinating is carried out in a stepwise manner, comprising: a first calcinating from ambient temperature to a reach a first temperature ranging from about 400° C. to about 450° C. (such as about 400° C.), and maintaining at the first temperature for about 1-3 hours (e.g., about 2 hours); a second calcinating from the first temperature to a second temperature ranging from about 450° C. to about 550° C. (such as about 500° C.), and maintaining at the second temperature for about 1-3 hours (e.g., about 2 hours); and a third calcinating from the second temperature to the final temperature, and maintaining at the final temperature for about 4-8 hours (e.g., about 6 hours).

Another embodiment of the present invention relates to a solid alumina composition prepared according to any process herein, wherein the solid alumina composition comprises n-alumina characterized by having an X-ray power diffraction pattern comprising the peaks at 19.6.0±0.5 and 66.8±0.5 °2θ.

Another embodiment of the present invention relates to a solid alumina composition above, wherein the solid alumina composition is an acid type, optionally having an acidity measured by a NH₃-TPD test characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment of the present invention relates to a solid alumina composition above, wherein the solid alumina composition comprises η-alumina at a high purity, characterized by the ratio of the peak intensity at 20.0 (±0.2)° 2θ relative to the peak intensity at 67.0 (±0.2)° 2θ being about 3% or greater (such as ranging from about 3% to about 10%, or from about 6% to about 10%).

Another embodiment of the present invention relates to a process for hydrocracking a carbon-containing feedstock, comprising: reacting a carbon-containing feedstock and hydrogen stream in the presence of a hydrocracking catalyst to produce an alkane-containing product stream; wherein the hydrocracking catalyst comprises a solid alumina composition as a catalyst support, wherein the solid alumina composition is prepared from a precursor composition comprising an alumina hydroxide (Al(OH)₃), aluminum oxyhydroxide (AlO(OH)), or a mixture thereof.

Another embodiment relates to any process herein, wherein the hydrocracking catalyst comprises at least one (e.g., two or more) transition metal or transition metal sulfide supported on the solid alumina composition.

Another embodiment relates to any process herein, wherein the metal of the transition metal or transition metal sulfide is a Group VI to Group X metal (such as Mo, W, Fe, Co, Ir, Ni, Pd, Pt, or combinations thereof).

Another embodiment relates to any process herein, wherein the transition metal or transition metal sulfide is Pt, Pd, Ir, Ni, Co, NiMo, CoMo, NiW, NiMOSₓ, NiWSₓ or FeSₓ.

Another embodiment relates to any process herein, wherein the carbon-containing feedstock is a petroleum-based virgin resin, bio-based resin, recycled resin (such as a post-consumer resin (PCR) or a post-industrial resin (PIR)), or combinations thereof.

Another embodiment relates to any process herein, wherein the carbon-containing feedstock is a polymer-based feedstock, such as a feedstock selected from the group consisting of polyolefins, polyvinyl chlorides, polyesters, polystyrenes, polyacrylates, polymethacrylates, polyamides, polycarbonates, and mixtures thereof.

Another embodiment relates to any process herein, wherein the reaction is carried out at a temperature ranging from 200 to 500° C. (e.g., from 300 to 450° C., from 350 to 450° C., from 400 to 450° C., or about 430° C.); and/or a hydrogen pressure ranging from 1 to 200 bar (e.g., from 5 to 100 bar, from 10 to 90 bar, from 20 to 80 bar, from 30 to 70 bar, from 45 to 55 bar, or about 50 bar).

Another embodiment relates to any process herein, wherein the alkane-containing product stream comprises C₁-C₂₀ hydrocarbons, such as C₁-C₂₀ alkanes.

Another embodiment relates to any process herein, further comprising the step of separating the alkane-containing product stream into two or more different product streams based on the molecular weight of the components of the alkane-containing product stream.

Another embodiment relates to any process herein, wherein two or more of the different product streams are selected from the group consisting of a C₁-C₃ product stream, a C₄-C₁₂ product stream, a C₁₃-C₂₀ product stream, and a C₂₀₊ product stream.

Another embodiment relates to any process herein, further comprising the step of pre-mixing the carbon-containing feedstock with a solvent medium, prior to the reacting step.

Another embodiment relates to any process herein, wherein the solvent medium comprises a liquid hydrocarbon or a liquid product stream (e.g., C₄-C₂₀ hydrocarbons; such as a diesel, kerosene or kerosene like product stream; preferably C₁₃-C₂₀ hydrocarbons) obtained from the hydrocracking reaction.

Another embodiment relates to any process herein, wherein the reaction has an improved selectivity toward a liquid product (e.g., C₄-C₂₀ hydrocarbons), wherein the selectivity is improved by at least 50% (such as at least 60%, at least 65%, at least 70%, at least 75%, at least 80%, at least 85%, at least 90%, at least 95%, or at least 100%), compared to a reaction carried out under the same conditions, using a same catalyst, but with a commercial γ-alumina catalyst support.

Another embodiment relates to any process herein, wherein the liquid product comprises C₄-C₁₂ hydrocarbons (such as C₄-C₁₂ alkanes) and/or C₁₃-C₂₀ hydrocarbons (such as C₁₃-C₂₀ alkanes).

Another embodiment relates to any process herein, wherein: the solid alumina composition comprises η-alumina characterized by having an X-ray powder diffraction pattern comprising the peaks at 19.6±0.5 °2θ (e.g., 19.6±0.2 °2θ) and 66.8±0.5 °2θ (e.g., 66.8±0.2 °2θ); and the solid alumina composition has an acidity measured by an NH₃-TPD test, characterized by: (1) an acid site density ranging from about 200 to 800 μmol/g (such as from about 250 to about 800, from about 300 to about 800, or from about 400 to about 800 μmol/g); and/or an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment relates to any process herein, wherein the solid alumina composition comprises η-alumina at a high purity, characterized by a ratio of a peak intensity at 19.6±0.5 °2θ (e.g., 19.6±0.2 °2θ), relative to a peak intensity at 66.8±0.5 °2θ (e.g., 66.8±0.2 °2θ), being about 3% or greater, preferably from about 3% to about 10%, or preferably from about 6% to about 10%.

Another embodiment relates to any process herein, wherein the alumina hydroxide comprises bayerite.

Another embodiment relates to any process herein, wherein the aluminum oxyhydroxide comprises boehmite (γ-AlO(OH)), pseudo-boehmite (e.g., finely crystalline boehmite), or a mixture thereof.

Another embodiment relates to any process herein, wherein the precursor composition comprises a mixture of bayerite and boehmite or pseudo-boehmite, optionally containing over 50 wt % (such as over 60 wt %, over 70 wt %, over 80 wt %, over 90 wt %, or over 95 wt %) bayerite.

Another embodiment relates to any process herein, wherein an acid to obtain the acid-treated precursor composition comprises an acid selected from the group consisting of an inorganic acid (e.g., sulfuric acid, boric acid, nitric acid, or a mixture thereof), a halogen acid (e.g., hydrochloric acid, hydrobromic acid, or a mixture thereof), an organic acid (e.g., acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, or a mixture thereof), and a mixture thereof.

Another embodiment relates to any process herein, wherein the acid comprises an acid selected from the group consisting of nitric acid, acetic acid, citric acid, malic acid, tartaric acid, and a mixture thereof.

Another embodiment relates to any process herein, wherein the solid alumina composition is prepared by a process comprising: treating a precursor composition comprising an alumina hydroxide (Al(OH)₃), aluminum oxyhydroxide (AlO(OH)), or a mixture thereof with an acid, to form an acid-treated precursor composition; dispersing the acid-treated precursor composition into a homogenous aqueous suspension of particles; drying the homogenous aqueous suspension of particles (e.g., at a temperature ranging from about 20° C. to about 200° C., preferably from about 50° C. to about 150° C., or preferably from about 90° C. to about 100° C.); and calcinating the dried particles (e.g., at a temperature ranging from about 400° C. to about 750° C., preferably from about 500° C. to about 650° C.), to form a solid alumina composition.

Another embodiment relates to any process herein, wherein the dispersing is carried out by sonication, stirring, shaking, or a combination thereof.

Another embodiment relates to any process herein, wherein the process for preparing the solid alumina composition further comprises: adding a surfactant (e.g., a cationic surfactant, an anionic surfactant, or a combination thereof) to the homogenous aqueous suspension of particles; and/or prior to calcinating, cooling the dried particles to an ambient temperature.

Another embodiment relates to any process herein, wherein the calcinating is carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

Another embodiment relates to any process herein, wherein the calcinating is carried out in a stepwise manner, comprising: a first calcinating from ambient temperature to a reach a first temperature ranging from about 400° C. to about 450° C. (such as about 400° C.), and maintaining at the first temperature for about 1-3 hours (e.g., about 2 hours); a second calcinating from the first temperature to a second temperature ranging from about 450° C. to about 550° C. (such as about 500° C.), and maintaining at the second temperature for about 1-3 hours (e.g., about 2 hours); and a third calcinating from the second temperature to the final temperature, and maintaining at the final temperature for about 4-8 hours (e.g., about 6 hours).

### BRIEF DESCRIPTION OF SEVERAL VIEWS OF THE DRAWING

FIG. 1 shows a XRPD patterns for γ-alumina and η-alumina.

FIG. 2 shows a compositional analysis of a product resulting from a liquefaction reaction.

### DETAILED DESCRIPTION OF THE INVENTION

The indefinite articles “a” and “an” generally mean “at least one” in the sense of “a” or “an”. The indefinite article “a” can also mean “any.” Those skilled in the art will understand that the indefinite article “a” does not necessarily mean the indefinite article “a” but rather the indefinite article “a” in the sense of “1”, and that in one embodiment the indefinite article “a” also includes the indefinite article “a” (1). Furthermore, the indefinite article can mean “one” or “at least one.”

### A Solid Alumina Composition

An embodiment of the present invention relates to a solid alumina composition prepared from an acid-treated precursor composition. The precursor composition comprises, consists of, or has, an alumina hydroxide (Al(OH)₃), aluminum oxyhydroxide (AlO(OH)), or a mixture thereof. The mixture can be any two or all of these components. The solid alumina composition can comprise, or consist of, η-alumina characterized by having an X-ray powder diffraction pattern comprising peaks at 19.6±0.5 °2θ and 66.8±0.5 °2θ.

The solid alumina composition can comprise, or have, an acidity measured by an NH₃-TPD test, characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%). The NH₃-TPD is described below, under Characterization Tests.

A solid alumina composition herein can comprise or have an acidity measured by an NH₃-TPD test, characterized by: (1) an acid site density ranging from about 200 to 800 μmol. The density can range from about 250 to about 800, or from about 300 to about 800, or from about 400 to about 800 μmol/g. All values between these minima and maxima are included in this description.

A solid alumina composition herein can comprise or have an acidity measured by an NH₃-TPD test, characterized by: (2) an acid strength distribution of: about 20%-70% weak acid sites, about 30%-80% medium acid sites, and about 0-20% strong acid sites. Regarding the weak acid sites, preferably, the range can be about 30-50%, or about 30-40%, or about 35-40%, relative to all acid sites in the solid alumina composition. All values between these minima and maxima are included in this description. Regarding the medium acid sites, preferably, the range can be about 50-70%, or about 60-70%, or about 60-65%), relative to all acid sites in the solid alumina composition. All values between these minima and maxima are included in this description. Regarding the strong acid sites, preferably, the range can be about 0-10%, or about 0-5%, or about 0-2%, relative to all acid sites in the solid alumina composition.

In an embodiment of a solid alumina composition herein, the solid alumina composition can comprise, or consist of, a η-alumina at a high purity. The high purity can be characterized by a ratio of a peak intensity at 19.6±0.5 °2θ, relative to a peak intensity at 66.8±0.5 °2θ, of the n-alumina, being about 3% or greater. Preferably, this ratio can be from about 3% to about 10%, or preferably from about 6% to about 10%. All values between these minima and maxima are included in this description.

In an embodiment, the alumina hydroxide of the solid alumina composition, can comprise, or consist of, bayerite. Alternatively, or in addition to bayerite, the aluminum oxyhydroxide can comprise, or consist of, boehmite (γ-AlO(OH)), pseudo-boehmite (e.g., finely crystalline boehmite), or a mixture thereof.

In an embodiment, the precursor composition can comprise, or consist of, a mixture of bayerite and boehmite or pseudo-boehmite, optionally containing over 50 wt %, preferably over 60 wt %, or over 70 wt %, or over 80 wt %, or over 90 wt %, or over 95 wt %, bayerite. All values between these minima and maxima are included in this description.

In an embodiment, the acid-treated precursor composition can be obtained by treating a precursor composition discussed herein with an acid. In embodiments, the acid can comprise, or consist of, an acid selected from the group consisting of an inorganic acid, a halogen acid, an organic acid, and a mixture thereof. In embodiments, the acid comprises an inorganic acid selected from the group consisting of sulfuric acid, boric acid, nitric acid, and a mixture thereof. In embodiments, the acid comprises a halogen acid selected from the group consisting of hydrochloric acid, hydrobromic acid, and a mixture thereof. These acids can be by themselves or in a mixture of any other acid listed herein.

In an embodiment of a solid alumina composition herein, the acid can comprise, or consist of, an organic acid selected from the group consisting of acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, and a mixture thereof. These acids can be by themselves or in a mixture of any other acid listed herein.

In an embodiment of a solid alumina composition herein, the acid can comprise, or consist of, an acid selected from the group consisting of nitric acid, acetic acid, citric acid, malic acid, tartaric acid, or a mixture thereof. These acids can be by themselves or in a mixture of any other acid listed herein.

### Process for Preparing a Solid Alumina Composition

Another embodiment of the present invention relates to a process for preparing a solid alumina composition, the process comprising: treating a precursor composition comprising an alumina hydroxide (Al(OH)₃), aluminum oxyhydroxide (AlO(OH)), or a mixture thereof with an acid, to form an acid-treated precursor composition; dispersing the acid-treated precursor composition into a homogenous aqueous suspension of particles; drying the homogenous aqueous suspension of particles; and calcinating the dried particles, to form a solid alumina composition.

In an embodiment of a process of preparing a solid alumina composition herein, the dispersing can be, or is, carried out by sonication, stirring, shaking, or a combination thereof.

In an embodiment of a process of preparing a solid alumina composition herein, the process can further comprise adding a surfactant to the homogenous aqueous suspension of particles. In embodiments, the surfactant can comprise, or consist of, a cationic surfactant, an anionic surfactant, or a combination thereof. In other embodiments, separate from or in addition to the cationic surfactant and/or anionic surfactant, the surfactant can comprise, or consist of, a non-ionic surfactant.

The cationic surfactant can comprise, or consist of, a salt of a quaternary ammonium cation selected from the group consisting of cetyltrimethylammonium, cetylpyridinium, polydially dimethyl ammonium, and a combination thereof. The anionic surfactant can comprise, or consist of, a surfactant selected from the group consisting of an alkyl sulfate, an alkyl-ether sulfate, an alkylbenzene sulfonate, a perfluoroalkanesulfonate, an alkyl-aryl ether phosphate, an alkyl ether phosphate, sodium stearate, and a combination thereof. The non-ionic surfactant can comprise, or consist of, at least one member selected from the group consisting of a fatty alcohol ethoxylate, an alkyl phenol ethoxylate, a fatty acid alkoxylate, an ethylene oxide/propylene oxide copolymer, and a poly(ethylene oxide)-based surfactant.

In embodiments, the poly(ethylene oxide)-based surfactant can comprise, or consist of, at least one of TERGITOL 15-S-5, TERGITOL 15-S-7, TERGITOL 15-S-9, and TERGITOL 15-S-12. In embodiments, the surfactant can comprise, or consist of, cetyltrimethylammonium bromide, poly-diallyldimethylammonium chloride, or TERGITOL 15-S-7.

In embodiments, the drying is carried out at a temperature ranging from about 20° C. to about 200° C., preferably from about 50° C. to about 150° C., or preferably from about 90° C. to about 100° C. In embodiments, the process can further comprise, prior to calcinating: cooling the dried particles to an ambient temperature.

In embodiments, the calcinating is carried out at a temperature ranging from about 400° C. to about 750° C., preferably from about 500° C. to about 650° C. The calcinating can be carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

In embodiments, the calcinating is carried out in a stepwise manner, that can comprise: a first calcinating from ambient temperature to a reach a first temperature ranging from about 400° C. to about 450° C. (such as about 400° C.), and maintaining at the first temperature for about 1-3 hours (e.g., about 2 hours); a second calcinating from the first temperature to a second temperature ranging from about 450° C. to about 550° C. (such as about 500° C.), and maintaining at the second temperature for about 1-3 hours (e.g., about 2 hours); and a third calcinating from the second temperature to the final temperature, and maintaining at the final temperature for about 4-8 hours (e.g., about 6 hours).

### Solid Alumina Composition Made by a Process

Another embodiment of the present invention relates to a solid alumina composition prepared according to any process herein, wherein the solid alumina composition comprises η-alumina characterized by having an X-ray power diffraction pattern comprising the peaks at 19.6.0±0.5 and 66.8±0.5 °2θ. The solid alumina composition can be an acid type, optionally having an acidity measured by a NH₃-TPD test characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

In another embodiment, in the solid alumina composition herein, the solid alumina composition can comprise η-alumina at a high purity, characterized by the ratio of the peak intensity at 20.0 (±0.2)° 2θ relative to the peak intensity at 67.0 (±0.2)° 2θ being about 3% or greater (such as ranging from about 3% to about 10%, or from about 6% to about 10%).

### Process for Hydrocracking Carbon-Containing Feedstocks.

Another embodiment of the present invention relates to a process for hydrocracking a carbon-containing feedstock, comprising: reacting a carbon-containing feedstock and hydrogen stream in the presence of a hydrocracking catalyst to produce an alkane-containing product stream; wherein the hydrocracking catalyst comprises a solid alumina composition as a catalyst support, wherein the solid alumina composition is prepared from a precursor composition comprising an alumina hydroxide (Al(OH)₃), aluminum oxyhydroxide (AlO(OH)), or a mixture thereof.

In embodiments, the hydrocracking catalyst can comprise at least one (e.g., two or more) transition metal or transition metal sulfide supported on the solid alumina composition. The metal of the transition metal or transition metal sulfide can be a Group VI to Group X metal (such as Mo, W, Fe, Co, Ir, Ni, Pd, Pt, or combinations thereof). Preferably, the metal comprises at least one of Mo, W, Fe, Co, Ir, Ni, Pd, and Pt. In embodiments, the transition metal or transition metal sulfide is Pt, Pd, Ir, Ni, Co, NiMo, CoMo, NiW, NiMOSₓ, NiWSₓ or FeSₓ.

In embodiments the carbon-containing feedstock can be a petroleum-based virgin resin, bio-based resin, recycled resin (such as a post-consumer resin (PCR) or a post-industrial resin (PIR)), or combinations thereof. For example, the carbon-containing feedstock can be a polymer-based feedstock, such as a feedstock selected from the group consisting of polyolefins, polyvinyl chlorides, polyesters, polystyrenes, polyacrylates, polymethacrylates, polyamides, polycarbonates, and mixtures thereof.

In embodiments, the reaction (reacting step) is carried out at a temperature ranging from 200 to 500° C. (e.g., from 300 to 450° C., from 350 to 450° C., from 400 to 450° C., or about 430° C.); and/or a hydrogen pressure ranging from 1 to 200 bar (e.g., from 5 to 100 bar, from 10 to 90 bar, from 20 to 80 bar, from 30 to 70 bar, from 45 to 55 bar, or about 50 bar). All values within these ranges are included.

In embodiments, wherein the alkane-containing product stream comprises C₁-C₂₀ hydrocarbons, such as C₁-C₂₀ alkanes. The carbon number can be 1, 2, 3, 4, 5, 6, 7, 8, 9, 10, 11, 12, 13, 14, 15, 16, 17, 18, 19, or 20. The alkane-containing product stream can comprise methane, ethane, propane, butane, pentane, hexane, heptane, octane, nonane, and decane.

Another embodiment relates to any process herein, further comprising the step of separating the alkane-containing product stream into two or more different product streams based on the molecular weight of the components of the alkane-containing product stream.

Another embodiment relates to any process herein, wherein two or more of the different product streams are selected from the group consisting of a C₁-C₃ product stream, a C₄-C₁₂ product stream, a C₁₃-C₂₀ product stream, and a C₂₀₊ product stream.

Another embodiment relates to any process herein, further comprising the step of pre-mixing the carbon-containing feedstock with a solvent medium, prior to the reacting step.

Another embodiment relates to any process herein, wherein the solvent medium comprises a liquid hydrocarbon or a liquid product stream (e.g., C₄-C₂₀ hydrocarbons; such as a diesel, kerosene or kerosene like product stream; preferably C₁₃-C₂₀ hydrocarbons) obtained from the hydrocracking reaction.

Another embodiment relates to any process herein, wherein the reaction has an improved selectivity toward a liquid product (e.g., C₄-C₂₀ hydrocarbons), wherein the selectivity is improved by at least 50% (such as at least 60%, at least 65%, at least 70%, at least 75%, at least 80%, at least 85%, at least 90%, at least 95%, or at least 100%), compared to a reaction carried out under the same conditions, using a same catalyst, but with a commercial γ-alumina catalyst support.

Another embodiment relates to any process herein, wherein the liquid product comprises C₄-C₁₂ hydrocarbons (such as C₄-C₁₂ alkanes) and/or C₁₃-C₂₀ hydrocarbons (such as C₁₃-C₂₀ alkanes).

Another embodiment relates to any process herein, wherein: the solid alumina composition comprises η-alumina characterized by having an X-ray powder diffraction pattern comprising the peaks at 19.6±0.5 °2θ (e.g., 19.6±0.2 °2θ) and 66.8±0.5 °2θ (e.g., 66.8±0.2 °2θ); and the solid alumina composition has an acidity measured by an NH₃-TPD test, characterized by: (1) an acid site density ranging from about 200 to 800 μmol/g (such as from about 250 to about 800, from about 300 to about 800, or from about 400 to about 800 μmol/g); and/or an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment relates to any process herein, wherein the solid alumina composition comprises η-alumina at a high purity, characterized by a ratio of a peak intensity at 19.6±0.5 °2θ (e.g., 19.6±0.2 °2θ), relative to a peak intensity at 66.8±0.5 °2θ (e.g., 66.8±0.2 °2θ), being about 3% or greater, preferably from about 3% to about 10%, or preferably from about 6% to about 10%.

Another embodiment relates to any process herein, wherein the alumina hydroxide comprises bayerite.

Another embodiment relates to any process herein, wherein the aluminum oxyhydroxide comprises boehmite (γ-AlO(OH)), pseudo-boehmite (e.g., finely crystalline boehmite), or a mixture thereof.

Another embodiment relates to any process herein, wherein the precursor composition comprises a mixture of bayerite and boehmite or pseudo-boehmite, optionally containing over 50 wt % (such as over 60 wt %, over 70 wt %, over 80 wt %, over 90 wt %, or over 95 wt %) bayerite.

Another embodiment relates to any process herein, wherein an acid to obtain the acid-treated precursor composition comprises an acid selected from the group consisting of an inorganic acid (e.g., sulfuric acid, boric acid, nitric acid, or a mixture thereof), a halogen acid (e.g., hydrochloric acid, hydrobromic acid, or a mixture thereof), an organic acid (e.g., acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, or a mixture thereof), and a mixture thereof.

Another embodiment relates to any process herein, wherein the acid comprises an acid selected from the group consisting of nitric acid, acetic acid, citric acid, malic acid, tartaric acid, and a mixture thereof.

Another embodiment relates to any process herein, wherein the solid alumina composition is prepared by a process comprising: treating a precursor composition comprising an alumina hydroxide (Al(OH)₃), aluminum oxyhydroxide (AlO(OH)), or a mixture thereof with an acid, to form an acid-treated precursor composition; dispersing the acid-treated precursor composition into a homogenous aqueous suspension of particles; drying the homogenous aqueous suspension of particles (e.g., at a temperature ranging from about 20° C. to about 200° C., preferably from about 50° C. to about 150° C., or preferably from about 90° C. to about 100° C.); and calcinating the dried particles (e.g., at a temperature ranging from about 400° C. to about 750° C., preferably from about 500° C. to about 650° C.), to form a solid alumina composition.

Another embodiment relates to any process herein, wherein the dispersing is carried out by sonication, stirring, shaking, or a combination thereof.

Another embodiment relates to any process herein, wherein the process for preparing the solid alumina composition further comprises: adding a surfactant (e.g., a cationic surfactant, an anionic surfactant, or a combination thereof) to the homogenous aqueous suspension of particles; and/or prior to calcinating, cooling the dried particles to an ambient temperature.

Another embodiment relates to any process herein, wherein the calcinating is carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

Another embodiment relates to any process herein, wherein the calcinating is carried out in a stepwise manner, comprising: a first calcinating from ambient temperature to a reach a first temperature ranging from about 400° C. to about 450° C. (such as about 400° C.), and maintaining at the first temperature for about 1-3 hours (e.g., about 2 hours); a second calcinating from the first temperature to a second temperature ranging from about 450° C. to about 550° C. (such as about 500° C.), and maintaining at the second temperature for about 1-3 hours (e.g., about 2 hours); and a third calcinating from the second temperature to the final temperature, and maintaining at the final temperature for about 4-8 hours (e.g., about 6 hours).

### Characterization Tests

NH₃-TPD test: The acidity (i.e. acid sites) of the solid alumina composition was characterized by ammonia temperature programmed desorption (NH₃-TPD) test, using AutoChem II instrument. The produced solid alumina composition was pretreated with 10 ccm Ar at 400° C. for 2 hours, and the sample was exposed to the flow of NH₃ in Ar for 1 hour at 50° C. After NH₃ exposure, the sample was purged under the flow of Ar for 1 hour to removed weakly adsorbed NH₃, followed by heating under the flow of Ar (10 ccm Ar) to 625° C. at 10° C./min.

The NH₃-TPD profile was measured using a mass spectrometer, to quantify the sample acid site concentration. The “weak” acid sites were defined as the acid sites having a desorption temperature lower than 200° C.; the “medium” acid sites were defined as the acid sites having a desorption temperature range from 200 to 450° C., and the “strong” acid sites were defined as the acid sites having a desorption temperature higher than 450° C. A detailed discussion of the NH₃-TPD experiment and procedure can be found in: J. L. Falconer, J. A. Schwarz, Temperature-programmed desorption and reaction: applications to supported catalysts, Catal. Rev. 25 (June 2) (1983) 141-227.

X-ray Powder Diffraction (XRPD): XRPD patterns were collected on a diffractometer (such as a PANalytical X'Pert PRO or equivalent) using an incident beam of Cu Kα radiation (45 kV, 40 mA), θ-θ goniometer, focusing mirror, divergence slit (½″), soller slits at both incident and divergent beam (4 mm) under ambient conditions. The data collection range was 3-35°2θ with a continuous scan speed of 0.2° s⁻¹.

The term “peak” refers to a signal that represents a reflection in the x-ray powder diffraction pattern. The peaks characterizing η-alumina in the x-ray powder diffraction pattern should be clear and distinct with low or minimum background noise.

### EXAMPLES

### Example 1

5.2 g of Bayerite hydroxide powder (PURAL BT from Sasol) was added to 50 mL of a 0.4M nitric acid solution under vigorous stirring. The suspension was sonicated for at least 10 minutes to achieve a homogeneous dispersion of the alumina hydroxide particles. Then, 0.2 g of a 20 wt % poly-diallyldimethylammonium chloride solution was added to the gel under vigorous stirring. The mixture was then dried in open container at 95° C. for 34 hours and cooled down to room temperature. The final alumina product, BCM-1, was obtained by further calcining the dried powder sample under air flow from room temperature to 400° C. with a ramp rate of 1° C./minute and kept for 2 hours, then to 500° C. with the same ramp rate and kept for 2 hours, and to 600° C. with the same ramp rate and kept for 6 hours.

Acid site measurements according to the NH₃-TPD Characterization Tests described herein were performed on BCM-1. The results are shown in Table 1.

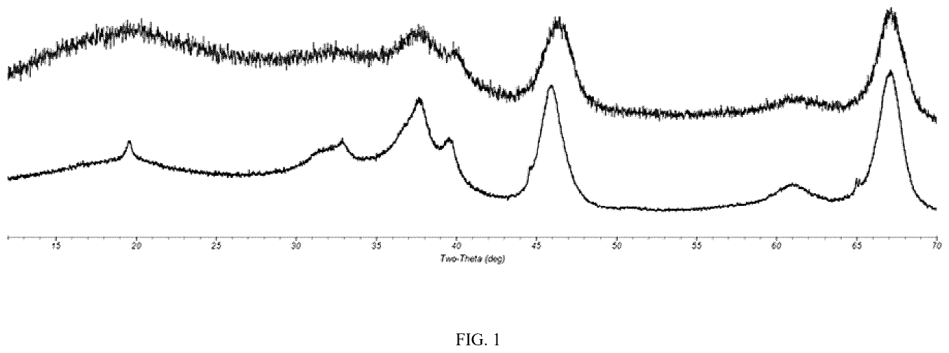

FIG. 1 shows XRPD patterns for γ-alumina and η-alumina of BCM-1. The top pattern is for the γ-alumina fraction of BCM-1, and the bottom pattern is for the η-alumina fraction of BCM-1. The XRPD patterns for BCM-1 were obtained via the X-ray Powder Diffraction method of the Characterization Tests described herein.

### Example 2

7.8 g of Bayerite hydroxide powder (PURAL BT from Sasol) was added to 80 g of deionized water and 10 mL of a 0.1M nitric acid solution under vigorous stirring. Then, 19.21 g of citric acid was slowly added to the solution under vigorous stirring at 80° C. The gel was stirred for at least 2 hours to ensure a homogeneous dispersion of the alumina hydroxide particles, before 2.6 g of TERGITOL 15-S-7 was added. The mixture was then dried in open container at 95° C. for 60 hours and cooled down to room temperature. The final alumina product was obtained by further calcining the dried powder sample under air flow from room temperature to 400° C. with a ramp rate of 1° C./minute and kept for 2 hours, then to 500° C. with the same ramp rate and kept for 2 hours, and to 600° C. with the same ramp rate and kept for 6 hours.

### Example 3

6.0 g of Bayerite hydroxide powder (PURAL BT from Sasol) was added to 60 mL of a 0.2M nitric acid solution under vigorous stirring. The suspension was sonicated for at least 10 minutes to achieve a homogeneous dispersion of the alumina hydroxide particles. Then, 0.6 g of a 20 wt % poly-diallyldimethylammonium chloride solution was added to the gel under vigorous stirring. The mixture was then dried in open container at 95° C. for 48 hours and cooled down to room temperature. The dried sample was further calcined under air flow from room temperature to 650° C. with a ramp rate of 1° C./minute and kept for 10 hours to obtain a final alumina product.

TABLE 1

| | Weak | Medium | Strong |
|---|---|---|---|
| Catalyst | acid sites | acid sites | acid sties |
| BCM-1 from Example 1 | 157 | 250 | 0 |
| Comparative γ-alumina | 137 | 46 | 11 |
| (CatalOX Sba-200 from | | | |
| Sasol) | | | |

### Example 4

### Catalyst Synthesis:

The catalyst used herein is an eta (ε) alumina-based material. It is solid alumina composition that may be prepared from an acid-treated precursor composition synthesized using alumina hydroxide (preferably Bayerite), or a mixture of alumina hydroxide and alumina oxyhydroxide with the former being the main component (preferably a mixture of Bayerite and Boehmite/Pseudo-boehmite with Bayerite being the main component), as the precursor material.

The synthesis process may involve (1) precursor material acid treatment, (2) dispersion, (3) surfactant enhancement, (4) drying, and (5) calcination.

An exemplary procedure for synthesizing an exemplary solid alumina composition suitable for hydrocracking is shown below.

5.2 g of Bayerite hydroxide powder (PURAL BT from Sasol) was added to 50 mL of a 0.4M nitric acid solution under vigorous stirring. The suspension was sonicated for at least 10 minutes to achieve a homogeneous dispersion of the alumina hydroxide particles. Then, 0.2 g of a 20 wt % poly-diallyldimethylammonium chloride solution was added to the gel under vigorous stirring. The mixture was then dried in open container at 95° C. for 34 hours and cooled down to room temperature. The final product was obtained by further calcining the dried powder sample under air flow from room temperature to 400° C. with a ramp rate of 1° C./minute and kept for 2 hours, then to 500° C. with the same ramp rate and kept for 2 hours, and to 600° C. with the same ramp rate and kept for 6 hours.

The NiMo-supported catalysts were synthesized using the sequential wetness impregnation method. Before synthesis, the solid alumina composition synthesized above as support were calcined at 550° C. for 4 hours under air. As comparison, commercial γ-Al₂O₃ supports were also calcined at 550° C. for 4 hours under air. Prior to synthesis, the nickel nitrate and ammonium heptamolybdate metal precursors were dissolved separately in deionized water to make an aqueous solution, based on the desired Ni to Mo weight ratio. The molybdenum precursor solution was impregnated into the calcined supports, followed by overnight drying at 110° C. After drying, the nickel precursor solution was impregnated, followed by overnight drying at 110° C. and calcination at 550° C. for 4 hours under air. For activity testing, the catalyst sample was reduced under the flow of hydrogen at 450° C. for 4 hours.

### Hydrocracking Reaction:

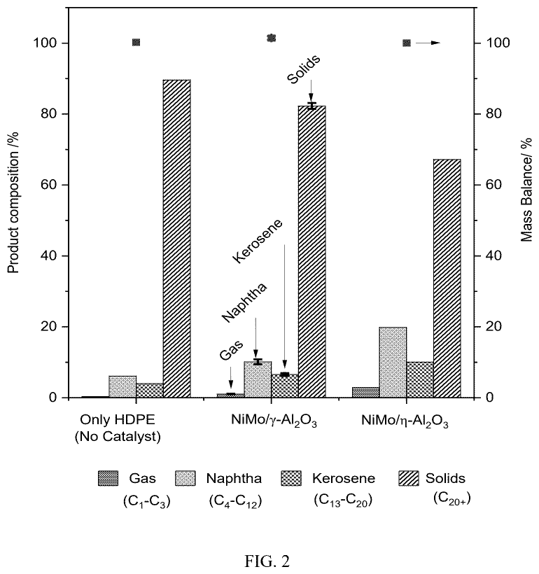

About 400 mg of virgin HDPE and 400 mg of the catalyst sample (NiMo/η-Al₂O₃—NiMo supported on the novel solid alumina composition described herein), prepared according to the procedure discussed above, was loaded inside a batch reactor. The reactor was purged with He several times before being pressurized with H₂ to 50 bar. It was then immersed in a fluidized sand bath, and the reaction was carried out for 1 hour at 430° C. The same experiment was carried out for virgin HDPE with NiMo supported on a commercial γ-Al₂O₃ support to serve as a comparative experiment (NiMo/γ-Al₂O₃). The same experiment was also carried out for virgin HDPE without catalyst to serve as the control experiment (Only HDPE, no catalyst). The results are shown in FIG. 2.

As shown in FIG. 2, under the same or similar reaction conditions, using the same NiMo catalyst, when using novel solid alumina composition described herein as the catalyst support, the yield of liquid components (naphtha+kerosene) increased significantly, compared to that using the commercial γ-Al₂O₃ as the catalyst support. Hence, the space-time yield of the liquid products is high when using novel solid alumina composition described herein as the catalyst support.

FIG. 2 provides the compositional analysis of the product resulted from the liquefaction reaction of HDPE feedstock, at a hydrogen pressure of 50 bar, 430° C., for 1 hour in the presence of the NiMo/η-Al₂O₃ catalyst (NiMo supported on the novel solid alumina composition described herein), compared to the compositional analysis of the product resulted from a comparative experiment (in the presence of NiMo supported on a commercial γ-Al₂O₃ support, NiMo/γ-Al₂O₃) and a control experiment (in the absence of a catalyst, Only HDPE, no catalyst), under the same reaction conditions. The graph shows the yields of various components (gas (C₁-C₃), naphtha (C₄-C₁₂), kerosene (C₁₃-C₂₀), and solids (C₂₀₊)) contained in the product using GC. The solid square ▪ for each bar represents the mass balance.

### Embodiments for Catalysts:

1. A solid alumina composition prepared from an acid-treated precursor composition, said precursor composition comprising an alumina hydroxide (Al(OH)₃), aluminum oxyhydroxide (AlO(OH)), or a mixture thereof;
wherein the solid alumina composition comprises η-alumina characterized by having an X-ray powder diffraction pattern comprising the peaks at 19.6±0.5 °2θ (e.g., 19.6±0.2 °2θ) and 66.8±0.5 °2θ (e.g., 66.8±0.2 °2θ); and
wherein the solid alumina composition has an acidity measured by an NH₃-TPD test, characterized by:
(1) an acid site density ranging from about 200 to 800 μmol/g (such as from about 250 to about 800, from about 300 to about 800, or from about 400 to about 800 μmol/g); and/or
(2) an acid strength distribution of:
about 20%-70% weak acid sites (such as about 30-50%, about 30-40%, or about 35-40%),
about 30%-80% medium acid sites (such as about 50-70%, about 60-70%, or about 60-65%), and
about 0-20% strong acid sites (such as about 0-10%, about 0-5%, or about 0-2%).

2. The solid alumina composition of catalyst embodiment 1, which comprises η-alumina at a high purity, characterized by a ratio of a peak intensity at 19.6±0.5 °2θ (e.g., 19.6±0.2 °2θ), relative to a peak intensity at 66.8±0.5 °2θ (e.g., 66.8±0.2 °2θ), being about 3% or greater, preferably from about 3% to about 10%, or preferably from about 6% to about 10%.

3. The solid alumina composition of catalyst embodiment 1, which has an acidity measured by an NH₃-TPD test, characterized by:
(1) an acid site density ranging from about 200 to 800 μmol.

4. The solid alumina composition of catalyst embodiment 1, which has an acidity measured by an NH₃-TPD test, characterized by:
(2) an acid strength distribution of:
about 20%-70% weak acid sites (such as about 30-50%, about 30-40%, or about 35-40%),
about 30%-80% medium acid sites (such as about 50-70%, about 60-70%, or about 60-65%), and
about 0-20% strong acid sites (such as about 0-10%, about 0-5%, or about 0-2%).

5. The solid alumina composition of catalyst embodiment 1, which comprises an acidity measured by an NH₃-TPD test, characterized by:

(1) an acid site density ranging from about 250 to about 800, preferably from about 300 to about 800, or preferably from about 400 to about 800 μmol/g.

6. The solid alumina composition of catalyst embodiment 1, wherein the alumina hydroxide comprises bayerite.

7. The solid alumina composition of catalyst embodiment 1, wherein the aluminum oxyhydroxide comprises boehmite (γ-AlO(OH)), pseudo-boehmite (e.g., finely crystalline boehmite), or a mixture thereof.

8. The solid alumina composition of catalyst embodiment 1, wherein the precursor composition comprises a mixture of bayerite and boehmite or pseudo-boehmite, optionally containing over 50 wt % (such as over 60 wt %, over 70 wt %, over 80 wt %, over 90 wt %, or over 95 wt %) bayerite.

9. The solid alumina composition of catalyst embodiment 1, wherein an acid to obtain the acid-treated precursor composition, comprises an acid selected from the group consisting of an inorganic acid, a halogen acid, an organic acid, and a mixture thereof.

10. The solid alumina composition of catalyst embodiment 9, wherein the acid comprises an inorganic acid selected from the group consisting of sulfuric acid, boric acid, nitric acid, and a mixture thereof.

11. The solid alumina composition of catalyst embodiment 9, wherein the acid comprises a halogen acid selected from the group consisting of hydrochloric acid, hydrobromic acid, and a mixture thereof.

12. The solid alumina composition of catalyst embodiment 9, wherein the acid comprises an organic acid selected from the group consisting of acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, and a mixture thereof.

13. The solid alumina composition of catalyst embodiment 9, wherein the acid comprises an acid selected from the group consisting of nitric acid, acetic acid, citric acid, malic acid, tartaric acid, or a mixture thereof.

14. A process for preparing a solid alumina composition, the process comprising:
treating a precursor composition comprising an alumina hydroxide (Al(OH)₃), aluminum oxyhydroxide (AlO(OH)), or a mixture thereof with an acid, to form an acid-treated precursor composition;
dispersing the acid-treated precursor composition into a homogenous aqueous suspension of particles;
drying the homogenous aqueous suspension of particles; and
calcinating the dried particles, to form a solid alumina composition.

15. The process of process embodiment 14, wherein the dispersing is carried out by sonication, stirring, shaking, or a combination thereof.

16. The process of process embodiment 14, further comprising:
adding a surfactant to the homogenous aqueous suspension of particles.

17. The process of process embodiment 16, wherein the surfactant comprises a cationic surfactant, an anionic surfactant, or a combination thereof.

18. The process of process embodiment 17, wherein the cationic surfactant comprises a salt of a quaternary ammonium cation selected from the group consisting of cetyltrimethylammonium, cetylpyridinium, polydially dimethyl ammonium, and a combination thereof, and
wherein the anionic surfactant comprises a surfactant selected from the group consisting of an alkyl sulfate, an alkyl-ether sulfate, an alkylbenzene sulfonate, a perfluoroalkanesulfonate, an alkyl-aryl ether phosphate, an alkyl ether phosphate, sodium stearate, and a combination thereof.

19. The process of process embodiment 17, wherein the non-ionic surfactant comprises at least one member selected from the group consisting of a fatty alcohol ethoxylate, an alkyl phenol ethoxylate, a fatty acid alkoxylate, an ethylene oxide/propylene oxide copolymer, and a poly(ethylene oxide)-based surfactant.

20. The process of process embodiment 19, wherein the poly(ethylene oxide)-based surfactant comprises at least one of TERGITOL 15-S-5, TERGITOL 15-S-7, TERGITOL 15-S-9, and TERGITOL 15-S-12.

21. The process of process embodiment 14, wherein the surfactant comprises cetyltrimethylammonium bromide, poly-diallyldimethylammonium chloride, or Tergitol 15-S-7.

22. The process of process embodiment 14, wherein the drying is carried out at a temperature ranging from about 20° C. to about 200° C., preferably from about 50° C. to about 150° C., or preferably from about 90° C. to about 100° C.

23. The process of process embodiment 14, further comprising, prior to calcinating:
cooling the dried particles to an ambient temperature.

24. The process of process embodiment 14, wherein the calcinating is carried out at a temperature ranging from about 400° C. to about 750° C., preferably from about 500° C. to about 650° C.

25. The process of process embodiment 14, wherein the calcinating is carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

26. The process of process embodiment 17, wherein the calcinating is carried out in a stepwise manner, comprising:
a first calcinating from ambient temperature to a reach a first temperature ranging from about 400° C. to about 450° C. (such as about 400° C.), and maintaining at the first temperature for about 1-3 hours (e.g., about 2 hours);
a second calcinating from the first temperature to a second temperature ranging from about 450° C. to about 550° C. (such as about 500° C.), and maintaining at the second temperature for about 1-3 hours (e.g., about 2 hours); and
a third calcinating from the second temperature to the final temperature, and maintaining at the final temperature for about 4-8 hours (e.g., about 6 hours).

27. A solid alumina composition prepared according to the process of process embodiment 14, wherein the solid alumina composition comprises η-alumina characterized by having an X-ray power diffraction pattern comprising the peaks at 19.6.0±0.5 and 66.8±0.5 °2θ.

28. The solid alumina composition according to solid alumina composition embodiment 27, wherein the solid alumina composition is an acid type, optionally having an acidity measured by a NH₃-TPD test characterized by:
(1) an acid site density ranging from about 200 to 800 μmol/g (such as from about 250 to about 800, from about 300 to about 800, or from about 400 to about 800 μmol/g); and/or
(2) an acid strength distribution of:
   about 20%-70% weak acid sites (such as about 30-50%, about 30-40%, or about 35-40%),
   about 30%-80% medium acid sites (such as about 50-70%, about 60-70%, or about 60-65%), and
   about 0-20% strong acid sites (such as about 0-10%, about 0-5%, or about 0-2%).

29. The solid alumina composition of solid alumina composition embodiment 27, wherein the solid alumina composition comprises η-alumina at a high purity, characterized by the ratio of the peak intensity at 20.0 (±0.2)° 2θ relative to the peak intensity at 67.0 (±0.2)° 2θ being about 3% or greater (such as ranging from about 3% to about 10%, or from about 6% to about 10%).

1: A process for hydrocracking a carbon-containing feedstock, comprising:
reacting a carbon-containing feedstock and hydrogen stream in the presence of a hydrocracking catalyst to produce an alkane-containing product stream;
wherein the hydrocracking catalyst comprises a solid alumina composition as a catalyst support, wherein the solid alumina composition is prepared from a precursor composition comprising an alumina hydroxide (Al(OH)₃), aluminum oxyhydroxide (AlO(OH)), or a mixture thereof.

2: The process of claim 1, wherein the hydrocracking catalyst comprises at least one transition metal or transition metal sulfide supported on the solid alumina composition.

3: The process of claim 2, wherein the metal of the transition metal or transition metal sulfide is a Group VI to Group X metal.

4. (canceled)

5: The process of claim 1, wherein the carbon-containing feedstock is a petroleum-based virgin resin, bio-based resin, recycled resin, or combinations thereof.

6. (canceled)

7: The process of claim 1, wherein the reaction is carried out at
a temperature ranging from 200 to 500° C.; and/or
a hydrogen pressure ranging from 1 to 200 bar.

8: The process of claim 1, wherein the alkane-containing product stream comprises C₁-C₂₀ hydrocarbons.

9: The process of claim 1, further comprising
separating the alkane-containing product stream into two or more different product streams based on the molecular weight of the components of the alkane-containing product stream.

10: The process of claim 9, wherein two or more of the different product streams are selected from the group consisting of a C₁-C₃ product stream, a C₄-C₁₂ product stream, a C₁₃-C₂₀ product stream, and a C₂₀₊ product stream.

11: The process of claim 1, further comprising
pre-mixing the carbon-containing feedstock with a solvent medium, prior to the reacting.

12: The process of claim 11, wherein the solvent medium comprises a liquid hydrocarbon or a liquid product stream obtained from the hydrocracking reaction.

13: The process of claim 1, wherein the reaction has an improved selectivity toward a liquid product, wherein the selectivity is improved by at least 50%, compared to a reaction carried out under the same conditions, using a same catalyst, but with a commercial γ-alumina catalyst support.

14: The process of claim 13, wherein the liquid product comprises C₄-C₁₂ hydrocarbons and/or C₁₃-C₂₀ hydrocarbons.

15: The process of claim 1, wherein:
the solid alumina composition comprises η-alumina characterized by having an X-ray powder diffraction pattern comprising the peaks at 19.6±0.5 °2θ and 66.8±0.5 °2θ; and
the solid alumina composition has an acidity measured by an NH₃-TPD test, characterized by:
(1) an acid site density ranging from about 200 to 800 μmol/g; and/or
(2) an acid strength distribution of:
a. about 20%-70% weak acid sites,
b. about 30%-80% medium acid sites, and
c. about 0-20% strong acid sites.

16: The process of claim 15, wherein the solid alumina composition comprises η-alumina at a high purity, characterized by a ratio of a peak intensity at 19.6±0.5 °2θ, relative to a peak intensity at 66.8±0.5 °2θ, being about 3% or greater.

17: The process of claim 15, wherein the alumina hydroxide comprises bayerite.

18: The process of claim 15, wherein the aluminum oxyhydroxide comprises boehmite (γ-AlO(OH)), pseudo-boehmite, or a mixture thereof.

19. (canceled)

20: The process of claim 15, wherein an acid to obtain an acid-treated precursor composition comprises an acid selected from the group consisting of an inorganic acid, a halogen acid an organic acid, and mixtures thereof.

21. (canceled)

22: The process of claim 1, wherein the solid alumina composition is prepared by a process comprising:
treating a precursor composition comprising an alumina hydroxide (Al(OH)₃), aluminum oxyhydroxide (AlO(OH)), or a mixture thereof with an acid, to form an acid-treated precursor composition;
dispersing the acid-treated precursor composition into a homogenous aqueous suspension of particles;
drying the homogenous aqueous suspension of particles; and
calcinating the dried particles, to form a solid alumina composition.

23-26. (canceled)
